(19) United States
(12) Patent Application Publication
(10) Pub. No.: US 2004/0118301 A1
(43) Pub. Date: Jun. 24, 2004

(54) Multi layer griddle plate with perforated bottom layer

(76) Inventor: Banu Yalniz, Istanbul (TR)

Correspondence Address: Banu Yalniz, Yildiz Posta Cad. 34 B 35 Gayrettepe, Istanbul, 80220, TR

(21) Appl. No.: 10/327,807

(22) Filed: Dec. 24, 2002

(51) Int. Cl. A47J 37/10; A47J 9/00

(52) U.S. Cl. 99/422

(57) ABSTRACT

The invention is a multi layer metal griddle plate (referred to as “Multi Layer Plate” or “MLP” hereinafter) to be used with griddles (grills) instead of steel plate to increase the performance of griddles in several aspects. MLP consists of at least three metal sheets or metal plates with different thickness and quality pressed together under certain pressure and temperature where the bottom layer is always perforated. Although the production process for multi layer plates is already in existence, MLP is the only multi layer plate with perforated bottom and the only plate designed specifically for griddles.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable

### BACKGROUND OF THE INVENTION

Griddles are used in restaurants from the first order of bacon at breakfast to the last seared steak at dinner. The Griddle is a “workhorse” that usually constitutes the central position on the short-order line. Griddles are commonly constructed by using a ½-2 inch thick steel plate, which has splashguards attached to the sides and rear. The cooking surface is usually 20-32 inches deep, with nominal widths varying from 2 to 8 feet. The griddle plate is heated from underneath by various energy sources such as tube burners, infrared burners, steam heating etc.

There are at the moment three major areas, which need further development in order to make Griddles more effective and user friendly.

1) The cooking performance of a gas griddle is very important in that substantial operating cost savings can be realized and pollution can be prevented by using high performance griddles. According to the American Society for Testing and Materials ASTM (Designation: F 1275-99) griddles performance is evaluated by taking the following factors into consideration.

a) Energy input rate

b) Temperature uniformity across the cooking surface and accuracy of the thermostats

c) Preheat energy and time

d) Idle energy rate

e) Pilot energy rate

f) Cooking energy rate and efficiency, and

g) Production capacity and cooking surface temperature recovery time

Each part of a griddle has a certain effect on these factors, but the most significant effect on the performance of the griddle derives from the griddle plate. Depending on the thickness and size of the plate most of the above listed factors are affected accordingly. Although steel has relatively low thermal conductivity compared to aluminum, copper etc., it has high durability and hardness, which makes steel the only material used for griddle plates at the moment.

2) During the operation period various types of food (bacon, steak, fish, onion, tomato etc) are cooked on the griddle hence it is very important that different tastes are not mixed. The surface of a normal steel griddle plate is porous and can easily absorb oil, fat, blood etc. thereby making it difficult to clean and thus enabling the mixage of the different tastes. Some manufacturers have introduced steel plates with chrome surface to abandon these problems but they are difficult to produce and therefore very costly.

3) Gas griddles are very heavy the biggest portion being the steel plate with 165 lbs to 450 lbs depending on its size. This makes the griddles difficult to carry and thus difficult to clean, and most importantly this unnecessarily enhances the transportation costs.

### BRIEF SUMMARY OF THE INVENTION

MLP will be used instead of the steel plate and will introduce improvements to each area mentioned above.

1) MLP consists of at least three metal plates or metal sheets of different thickness and quality, where the first layer at the bottom is always perforated. The material of the bottom layer is steel or stainless steel. The perforation of the bottom layer will not only minimize the reflection of the coming heat from the heat sources below but will also make heat transmission easier to the medium layer, which has high thermal conductivity.

The medium layer can consist of one or multi metal sheet or plate combinations with higher thermal conductivity than steel, preferably aluminum, copper, etc. and this improves the following performance factors of the griddle,

a) Temperature uniformity across the cooking surface

b) Preheat energy and time

c) Cooking energy rate and efficiency

d) Cooking surface temperature recovery time

2) The top layer is polished chrome steel with the following advantages;

a) Non-corrosive surface.

b) Because it does not absorb oil, fat, blood, etc., the different tastes of steak, fish, onion, bacon etc. do not get mixed.

c) Easy to clean

d) Has better scratch resistance as compared to steel and can be hard chrome plated if desired.

3) Multi Layer Plate (MLP) compared to steel plate has a significant weight advantage. The smallest sized steel plate of 1″×24″×24″ weighs about 165 lbs, on the other hand an MLP of the same size and with higher efficiency weighs only 30 lbs. This not only results in big savings but also makes the griddle easy to handle and easy to clean.

### BRIEF DESCRIPTION OF THE SEVERAL VIEWS OF THE DRAWING

Not Applicable

### DETAILED DESCRIPTION OF THE INVENTION

As mentioned above MLP consists of at least three metal plates or metal sheets of different thickness and quality. The materials of each layer and specifications thereof are of each layer are delineated below.

1) Bottom Layer: The material of the bottom layer is steel or stainless steel. Since this layer is the first layer confronted with the heat source, it is perforated to enable energy to pass on the second layer without any reflection. The thickness of this layer varies depending on the design of the perforation. There is practically no limitation as to the design of the perforation as long as the holes are not too small preventing an easy heat transfer nor too big causing a weak layer.

2) Medium Layer: The medium layer can consist of one or multi metal sheet or plate combinations. This layer has high thermal conductivity and is the most substantial effect on the performance of the griddle. Therefore the material of this layer is generally aluminum, aluminum alloys or aluminum-copper combinations, which have high thermal conductivity. The thickness of this layer varies depending on the material used and design of the perforation.

3) Top Layer: The thickness of the top layer must be selected in accordance to the bottom layer so that the evolving stress between layers during and after production is diminished. This layer is the cooking surface of MLP and must meet the hard working conditions; this makes chrome steel the preferred material. The surface of this layer must be polished. Optionally the surface of the layer can be hard chrome plated as well.

Production: The three layers described above are preheated to 550 F-1300 F and pressed together by rollers or friction presses under certain pressure depending on the thickness of the layers and process conditions. During pressing the air between the layers is eliminated entirely so that the layers are all affixed together. The production process itself is not the subject of my invention since this process is already known to the industry and the products are already being marketed under trademarks such as Clad, Ply etc. Although the process is already known, my invention is noble in that it is the only multi layer plate with perforated bottom layer and specifically designed for griddles.

1. What I claim as my invention is a multi layer plate with a perforated bottom layer for griddles.
